(19) United States
(12) Patent Application Publication
(10) Pub. No.: US 2010/0274519 A1
(43) Pub. Date: Oct. 28, 2010

(54) FUNCTIONAL TESTING METHOD AND DEVICE FOR AN ELECTRONIC PRODUCT

(75) Inventor: Marco Marcinno', Groscavallo (IT)

Correspondence Address: MERCHANT & GOULD PC, P.O. BOX 2903, MINNEAPOLIS, MN, 55402-0903, US

(73) Assignee: CREA - COLLAUDI ELETTRONICI AUTOMATIZZATI S.R.L., Torino (IT)

(21) Appl. No.: 12/742,617

(22) PCT Filed: Nov. 12, 2008
(86) PCT No.: PCT/IB2008/054743

§ 371 Date: May 12, 2010

(30) Foreign Application Priority Data
Nov. 12, 2007 (EP) 07425712.2

(51) Int. Cl. G06F 19/00

(52) U.S. Cl. 702/122

(57) ABSTRACT

A functional testing method of electronic products includes writing a document defining a functional specification of a product by a structured document according to a recursive model of a functional specification, so that this is comprehensible by human and non-human interpreters, thus automating the setting up of a functional testing apparatus of electronic products. The functional testing apparatus is adapted to interpret the document, is general-purpose and includes an interface with corresponding drivers, replaceable in relation to the type of product subject to functional test.

### FIELD OF THE INVENTION

The present invention relates to the field of electronic board or apparatus testing, and more specifically to a functional testing method and device for an electronic product.

### STATE OF THE ART

There is a remarkable gap in the known art concerning the transfer of information from the design to the automatic functional testing systems. Currently, the transfer takes place by means of a written documentation in human language, the so-called functional specification. It is also widespread opinion that the design responsibility regarding the arrangement of such information is not clearly assigned.

Specifically, in order to test the performances of a product, a functional specification describes what needs to be done, with what means and in which sequence.

This gap, i.e. the use of a human language for treating fundamental information for the industrialization of a product, is translated into a considerable cost in terms of human resources and time.

As a consequence, the document expressed in human language must be interpreted to make a functional testing apparatus. Furthermore, each apparatus is dedicated to that specific product. In other words, in the current state of affairs, it is impossible to make general purpose functional testing systems.

The functional test of electronic boards is a known and needed requirement to verify that an electronic product works according to specifications However it is a need which arises in three different moments of the life of an electronic product, i.e. during prototyping, production and repairing, functional testing is normally recognized as a production need, i.e. that trial which must be performed at the end of the production, before delivering the product.

The industrialization process of electronic boards and systems has also set up other types of tests which focus on other aspects but which may be grouped into a category named category of components or circuit category: in-circuit test, boundary scan, optical inspection, X-ray inspection.

All these procedures essentially differ from the functional test because they do not consider how the components interact, how they “work” exactly, but only whether the single parts are present and in tolerance with respect to the design information and the industrial process quality, in terms of welding and assembly.

Therefore, the analysis results to be related to the functionality of the single components loosing sight of the reason why they have been combined together to form the product.

In medium-small sized companies, the designer himself/herself may provide support for the design of the functional testing system and a system is able to cover the testing of the entire whole of that company's products with some difficulties.

The typical layout of an automatic or semiautomatic functional tester contemplates a PC connected to a testing system which by means of an adapting interface allows to test a product.

The company's own boards or boards supplied by third parties may be used for making testing systems. The same applies to the software for controlling the system.

No one provides a development environment of the functional specification, with a separation between the informative part and the executive part, regardless of the hardware used.

In other words, a software environment is used for the electronic designing, while the so-called functional testing documentation is written before, during and after the step of designing, to the extent that only during the step of testing it is possible to highlight any possible discrepancies between what is shown in the documentation and what has been really designed.

The products provided by the known art intend to make tools for developing a software for testing systems available to users without programming notions, in a simple manner e.g. graphically, but do not offer any support in writing the functional specification which must be a document which develops hand-in-hand with the project.

With regard to the functional aspect, the following steps may be identified in the current industrialization processes of an electronic product:
defining a functional specification;
writing a text in informal human language;
interpreting said text by one or more people;
setting up a dedicated system, also beginning from the use of general-purpose commercial products, which must be adapted to the various needs.

The foregoing schematization shows two considerable gaps: the first one is the lack of a standardized functional specification model with the consequent need for one or two people who must design and make a testing system. This determines costs in terms of:
human resources
time needed to implement the testing systems
errors generated by the interpretation of the human language text: during testing system verification it is often necessary to go from production back to design: this means that something written in the functional specification is not coherent with the product.

The second is the lack of definition of the architectural requirements of a general-purpose functional testing system, such that a proliferation of hardware systems is produced, in which all systems are reciprocally similar but each one is dedicated to a single product, and are not only expensive in their replication but also expensive in their maintenance.

### SUMMARY OF THE INVENTION

It is the object of the present invention to provide a functional testing method for an electronic product.

Therefore, the present invention aims at reaching the objects discussed above by means of a functional testing method for an electronic product which, according to claim 1, is adapted to be implemented on data processing means controlling at least one analogue/digital hardware interface with the electronic product to be tested, said hardware interface comprising corresponding software drivers; the method comprising the following steps:
reading a functional test specification document according to a recursive model of structured document;
driving said analogue/digital interface according to the previously implemented recursive model, comparing the correspondence between the electric/functional behaviour of the electronic product and said structured document;
   said recursive model defining a tree in which each node is an object or class which may comprise at least one second object adapted to contain at least one datum and adapted to be associated with at least one driver of said analogue/digital hardware interface.

A further object of the present invention is to provide a functional testing device of the general purpose type for an electronic product, working according to said method.

Therefore, the present invention aims at reaching the objects discussed above by means of a functional testing device for an electronic product which, according to claim 5, comprises: —analogue/digital hardware interfacing means with said electronic product adapted to generate electric input signals to the electronic product and adapted to acquire electric output signals from the electronic product for performing a functional testing trial;
processing means adapted to read a document of functional testing specification for said electronic product structured according to a recursive model and defining a tree in which each node is an object or class which comprises at least one second object adapted to contain at least one datum and adapted to be associated with said at least one analogue/digital hardware interface;
software interfacing means between said processing means and said hardware interfacing means, associated with at least one said second object.

A tree structure naturally defines one or more sequences of operations or steps to be performed, passing from a level node of the higher order to a lower one and between nodes of the same level, according to the tree generation order compliant with the formatting of the document defining the functional specification(s).

Therefore, the sequence of operations driven by the hardware interface by means of the processing process is automatically defined by reading the document which defines the functional features of the device, when the document is structured according to the model of the present invention.

Advantageously, only one device comprising hardware interface boards, both generating and acquiring analogue and/or digital signals, may be used for the functional testing of a plurality of electronic devices, by reading the corresponding, appropriately formatted, descriptive functional specification documents.

The choice of a programming language of the object-oriented type adapted to translate the described model into a routine is absolutely irrelevant with regards to the scope of the invention.

According to another aspect of the invention, said method finds its best application when a common software environment for assisting electronic designing integrates a tool which assists the definition of a functional specification which is then able to format said specification according to the model of the present invention and directly interpretable by said functional testing device. In this manner, the effort of writing said document in human language and then interpreting it for producing a specific testing system is avoided.

The dependent claims describe preferred embodiments of the invention.

### BRIEF DESCRIPTION OF THE DRAWINGS

Further features and advantages of the invention will be more apparent in the light of the detailed description of a preferred, but not exclusive, embodiment of a functional testing method and device for an electronic product illustrated by way of non-limitative example, with the aid of the accompanying drawings, in which:

FIG. 1 diagrammatically shows an electronic document writing defining a functional specification parallelly to the setting up of an electronic circuit or product, which is adapted to be automatically interpreted by a testing device;

FIG. 2 shows a recursive model, according to UML notation, of a tree in which each node is represented by a class or an object;

FIG. 3 shows a detailed model comprising the recursive model in FIG. 2;

FIG. 4 shows definition examples of the FunctionalSpecDoc, Step and Module classes.

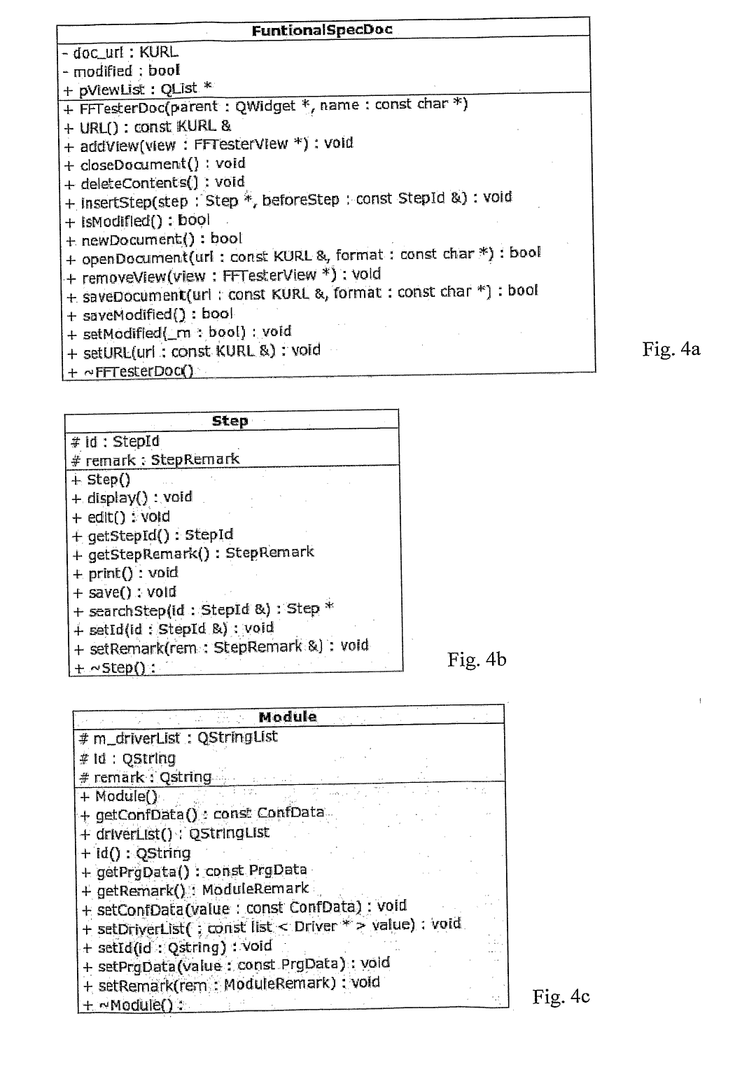

### DETAILED DESCRIPTION OF A PREFERRED EMBODIMENT OF THE INVENTION

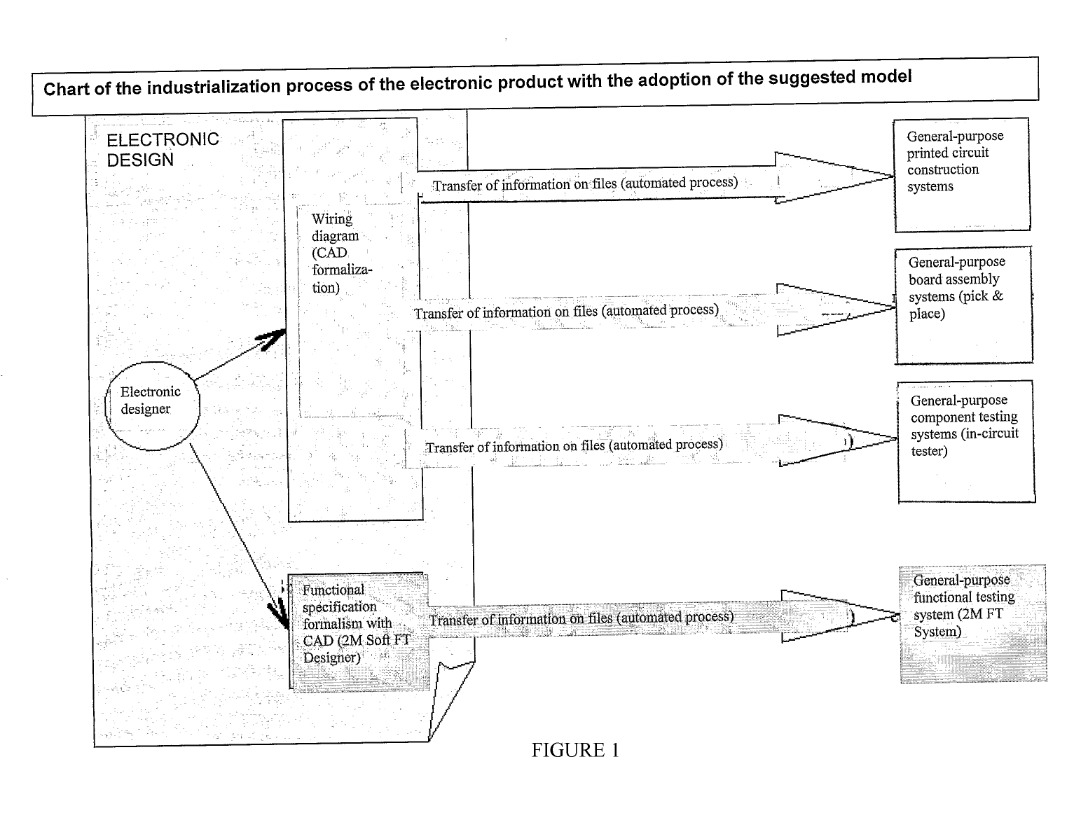

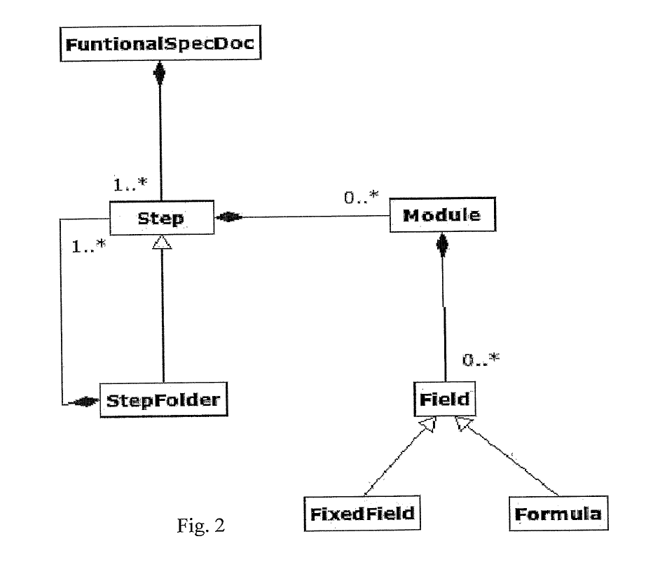

With reference to FIGS. 1 and 2, it is proposed a functional testing method of an electronic product adapted to be implemented on data processing means controlling at least one interface with the product to be tested of the analogue/digital type comprising corresponding software drivers; the method comprising the following steps:
reading a document structured according to a recursive model;
driving said analogue/digital interface according to the previously implemented recursive model, thus verifying the correspondence between the behaviour of the electronic product and said structured document.

The FunctionalSpecDoc block represents a document defining the functional specifications of a structured electric/electronic product. It comprises at least one Step object or class, from which a StepFolder object hereditarily derives, which contains at least one other Step object therein.

Each Step object contains at least one Module object, which may contain at least one Field object, from which a Fixed Field datum or a Formula datum may hereditarily derive, according to whether it is fixed or dependent.

The cycling of the StepFolder object on the Step object indicates a recursion which identifies a numerable infinite tree, in which the dependence between the nodes has a functional and temporal feature. For example, in the tree, the step which includes starting a component temporally precedes the modification of a working parameter of that component.

It is apparent for a person skilled in the art that such a structure may contain infinite zero-level numerable nodes immediately under the FunctionalSpecDoc block, each of which contains infinite numeral nodes with level 1, 2 and so on therein, defining a more or less branched tree structure in relation to the complexity of the document defining one or more functional tests.

Advantageously, this model thus represents a recursive structure implementable with any object-oriented programming language referable to recursions.

Furthermore, a branched tree structure naturally defines one or more sequences of operations or steps to be performed passing from a higher order level node to a lower one or among the same level nodes according to the tree generation order compliant with the formatting of the document defining the functional specification(s).

Therefore, the model in FIG. 2 is read by stating that the object FunctionalSpecDoc comprises at least one step, defined by a Step object.

The StepFolder objects are a specialization (hereditary) of the Step object, and thus they are also Steps, adapted to contain one or more Step objects (recursion).

Each step comprises from 0 to infinite numerable modules, defined by the Module object, and each module comprises from 0 to infinite numerable fields, defined by the Field object.

In the following description, it is worth underlining that, by defining a tree hierarchy node, a StepFolder object may indifferently be named either a StepFolder object or a node, regardless of its hierarchy level in the tree.

Therefore, by virtue of the hierarchic structure which binds a node of a level, parent node, to a node of a lower level or child node, a functional test condition, e.g. setting the supply voltage at 5V, specified in the FixedField field of at least one corresponding Module of a node, is specified and frozen for the children, grandchildren, etc. which hierarchically descend from the given parent node.

Advantageously, given values of physical magnitude or operating parameters must be set only once and modified from a certain step onwards, when required.

Furthermore, the values set in the fields may be considered either as value or reference, as occurs, for example, in electronic spreadsheets, and particularly in Formula type data which depend from other data.

When required, a child node may determine the variation of a working parameter from a certain step onwards, by taking the numeric value of a datum contained in the object related to a higher hierarchic node and by locally modifying, e.g. by multiplication, division, etc. Thus, from that step onwards, following the branching of the tree, said working parameter is modified.

It is apparent that this modeling does not explicitly refer to the executive part of the testing specification and thus to the functionality of the testing device.

In accordance with the present invention, the functional testing device implementing said method comprises:
means for interfacing the analogue/digital hardware with said electronic product, adapted to generate electric input signals for the electronic product and adapted to acquire electric output signals from the electronic product for performing a functional testing trial;
processing means adapted to read a document defining a functional specification of said electronic product and structured according to a recursive model defining a tree, in which each node is a Step object or class which comprises at least one second Module object adapted to contain at least one datum and adapted to be associated with at least one driver of said analogue/digital hardware interface;
software or drivers interfacing means between said processing means and said hardware interfacing means, associated with at least one said second Module object.

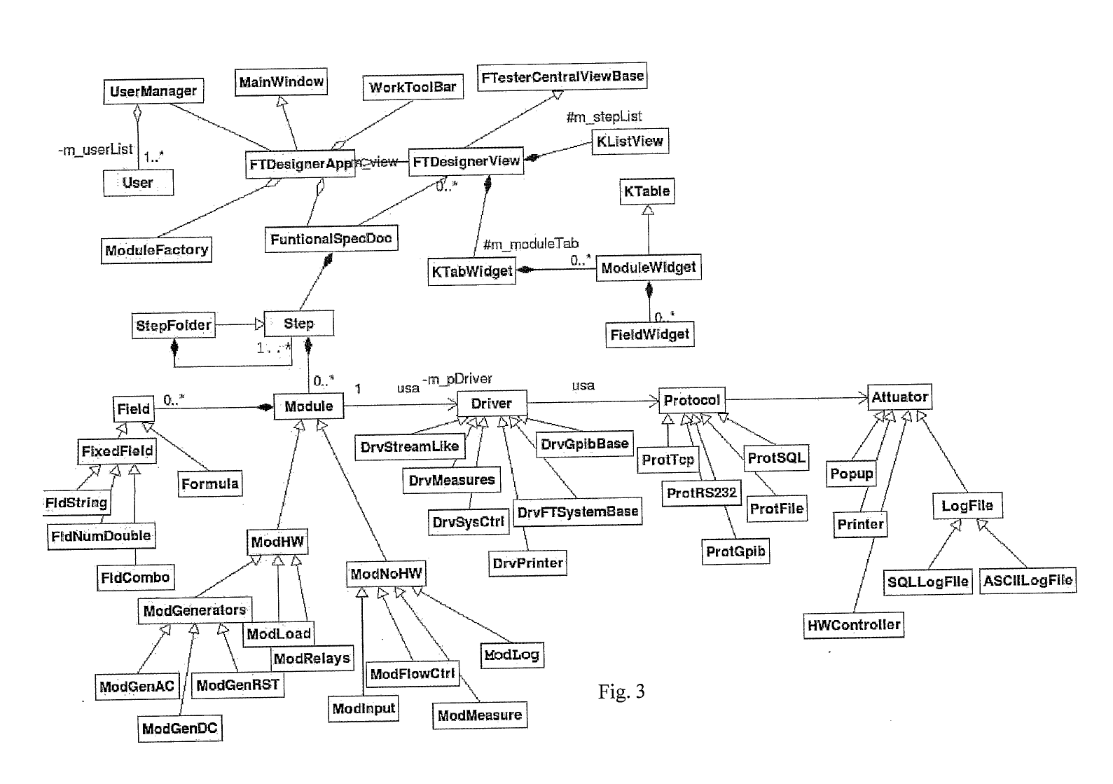

Said testing device interprets said document which defines the functional specification according to a method, also schematizable by means of UML notation, as shown in FIG. 3.

The Module object, as shown in FIG. 3, may be associated with a Driver object for driving a control board, rather than a signal generator, etc.

In relation to the functional document, the Module object may not contain any Field type object, which is to say that the Module object is not valorized and/or does not comprise or refer to any datum.

Therefore, by using for example XML to represent the document formalized according to the model in FIG. 2, defining a functional specification, a tree formed by nodes may be automatically generated, each node comprising at least one Module object.

At least one Module object associated with a Driver object which allows to drive an board interfacing with the electronic product to be tested.

The above-described model defining the functional specification is integrated in the central part of the diagram with the following objects: FunctionalSpecDoc, Step, StepFolder, Module, Field, FixedField and Formula.

Examples of definition of some of the aforesaid objects are shown in FIG. 5.

Thus, the Field object is implemented by FixedField objects of FldString type for strings, FldNumDouble for floating point numeric fields, FldCombo for selection fields having a predetermined value. As previously mentioned, a Formula object may depend on the value of a field of the same or of another module, possibly by means of a calculation on said value from which its depends. This function is very useful, for example, when aiming at setting the supply voltage of a given component to a value 10% higher than the nominal value. Therefore, the current value contained in a FixedField of a node, even hierarchically higher, is taken by a formula and divided by 0.9, thus obtaining said 10% reduction. However, it is also possible taking the values measured in that given step by another module.

Thus the Module object, which may be specialised in hardware controlling modules, e.g. with ModHW object, or in modules which do not control the hardware, such as the ModNoHW object, which are implemented by the ModGenerators objects and their derivates ModGenAC, ModGenDC and ModGenRST for generators, ModLoad for loads and ModRelays for relays, ModInput for the operator interface hardware, ModFlowCtrl for the execution flow control, such as cycles, breaks, parallelism/sequencing; ModMeasure for the step validation, ModLog for the measured data collection, respectively.

It is worth noting the separation of the informative part, i.e. the functional specification, from the executive part, which drives said analogue/digital interface with the electronic product to be tested. Said hardware is represented by the Attuator object, which more generally represents also the other devices involved during the testing. Thus, the modules become executive by means of the Attuator object by virtue of a driver defined by the Driver object which transfers the information contained in Module to Attuator by means of a protocol defined by the Protocol object.

Likewise, the Driver object is specialised by the DrvStreamLike objects for all the modules which have actuators which are managed by means of a data stream, DryMeasures for the step validating module, DrvSysCtrl allowing to modify the step execution stream, which may be either a cycle, or a stop, or a break, or a parallelism/sequencing; DrvGpibBase for the basic management module of the instruments connected to the standardized GPIB interface according to the IEEE488 standard; DryPrinter for managing the output towards printers; DrvFTSystemBase for managing all the modules implemented for the general-purpose functional testing system.

Likewise, the Protocol object is implemented by the ProtTCP objects for the TCP/IP protocol; ProtRS232 for the RS232 protocol; ProtGpib for the GPIB protocol; ProtFile for referring to local or remote file systems; ProtSQL for accessing a SQL database.

Likewise, the Attuator object is implemented by the Popup objects for managing the screen displays to interact with an operator; Printer defines a local or remote printer; LogFile is a collection of test data which may be defined by SQLLogFile, thus in a SQL database or ASCIILogFile in a ASCII file; HWController defines a smart manager of the hardware modules implemented for the general-purpose functional testing system which may be a common CPU board, a relay board, a generator, a load or any combination of foregoing hardware modules. A further common board may be a digital I/O with 2 digital/analogue DAC channels and 2 analogue/digital ADC channels with floating scale management.

This board, which may be implemented for the functional test, is the base to control any generator/load hardware module, to analyze the digital and analogue signals and to measure them.

All these objects are included in a FTDesignerApp object which provides for managing the users by means of the UserManager and User classes, and which contains a collection of modules such as the ModuleFactory class, a main window defined by the MainWindow object, a working tool bar defined by the WorkToolBar object and one or more functional testing specification views defined by the FTDesignerView object.

Except for the latter object, the other objects are typical of any framework library for window applications (Windows, KDE/Linux). Reference shall be made to the development of applications with event-driven graphic interfaces for implementing details.

On the other hand, the FTDesignerView object defines the displaying of the functional specification on the monitor.

There may be various views, by modules, by steps, etc.

A KlistView object defines a hierarchic list for containing the list of steps and the view of the module defined by the ModuleWidget object, which may be contained in a folder defined by the KtabWidget object as in electronic spreadsheets. The ModuleWidget may be derived from an object which implements a table defined by the Ktable object, again similar to the electronic spreadsheet. Moreover, the ModuleWidget consists of views of various field defined by the FieldWidget object.

The view intended to be used by an operator-repairer is instead organized in a container in which there are all the hardware driving modules a, e.g. ModHW, and with only the main fields, so as to be able to stop the test at the first step in which a fault appears, allowing a more convenient repair because it is possible to vary the module parameters, i.e. the Module objects, so that the inputs of a certain component defining the board under testing are varied.

With regards to the views, it is preferable to implement the so-called concept of document-view which can be implemented using any framework library with event-driven graphic interface and it is thus possible to organize more suitable views of the functional specification document for the end user and also as higher level of data abstraction (predetermined steps as specific test library for the application). This is a further development of the application which does not modify the basic layout.

A preferred embodiment of said device comprises a further integrated software working environment, which assists the electronic designing and is adapted to simultaneously and automatically write said document defining said functional specification. Therefore, said document may be written by means of an appropriate distinct tool (i) separate from the electronic designing environment.

In another preferred embodiment, said tool is integrated (ii) in said electronic designing environment, so that said document is automatically written during the electronic design by the designing environment itself.

In a further preferred embodiment, said electronic designing environment integrating said functional specification writing tool is integrated (iii) in the functional testing device.

In another preferred embodiment, said functional testing device simultaneously integrating said electronic designing environment adapted to automatically write said document defining a functional specification, further comprises (iv) means for the automatic production of an electronic board or product designed by means of said electronic designing environment.

In the latter embodiment, it is apparent that a single apparatus may be used to design an electronic board, to write a functional specification thereof, to manufacture the designed board and to test it.

Specifically, with reference to FIG. 1, an electronic designer is, by virtue of the present invention, conditioned to simultaneously define both the circuit and the function and performance features of the product.

An example of an XML structured document of a functional specification is shown, which is useful for testing an electric generator with two 5 and 12 Volt outputs and represents the following example document of functional test specification in informal human language: “Switch the device on by supplying 110 Vac. Check that with no load, voltage is 5Vdc±5% at the +5V output. Check that with no load, voltage is 12 Vdc±5% at the +12V output. Connect a 1A active load to the +5V output and check that voltage is 5V±5%. Connect a 1A active load to the +12V output and check that voltage is 12V±5%. Perform the same tests by supplying 220 Vac in input”; the document is structured according to the recursive model shown in FIG. 2.

<FunctionalSpecDoc>
<Name>Power supplier with 2 output +5V e +12V

(example)</Name>

```
  <Step>
  <Name>Initial Conditions</Name>
  <Module>
    <Name>ACGEN</Name>
    <Field>
    <Name>Status</Name>
    <Value>On</Value>
    </Field>
    <Field>
    <Name>Main</Name>
    <Value>0</Value>
    </Field>
  </Module>
  <Module>
    <Name>LOAD1</Name>
    <Field>
    <Name>Status</Name>
    <Value>Connected</Value>
    </Field>
    <Field>
    <Name>Main</Name>
    <Value>0</Value>
    </Field>
  </Module>
  <Module>
    <Name>LOAD2</Name>
    <Field>
    <Name>Status</Name>
    <Value>Connected</Value>
    </Field>
    <Field>
    <Name>Main</Name>
    <Value>0</Value>
    </Field>
  </Module>
  <Module>
    <Name>MEASURE</Name>
    <Field>
      <Name>Formula</Name>
      <Value/>
    </Field>
    <Field>
      <Name>ThMin</Name>
      <Value/>
    </Field>
    <Field>
      <Name>ThMax</Name>
      <Value/>
    </Field>
    </Module>
    <Step>
    <Name>Prove a 110Vac</Name>
    <Module>
      <Name>ACGEN</Name>
      <Field>
      <Name>Main</Name>
      <Value>110</Value>
      </Field>
    </Module>
    <Step>
      <Name>+5V @ 0A</Name>
      <Module>
      <Name>MEASURE</Name>
      <Field>
      <Name>Formula</Name>
      <Value>=LOAD1::Vdc( )</Value>
    </Field>
    <Field>
      <Name>ThMin</Name>
      <Value>4,75</Value>
    </Field>
    <Field>
      <Name>ThMax</Name>
      <Value>5,25</Value>
    </Field>
    </Module>
  </Step>
  <Step>
    <Name>+12V @ 0A</Name>
    <Module>
    <Name>MEASURE</Name>
    <Field>
      <Name>Formula</Name>
      <Value>=LOAD2::Vdc( )</Value>
    </Field>
    <Field>
      <Name>ThMin</Name>
      <Value>11,4</Value>
    </Field>
    <Field>
      <Name>ThMax</Name>
      <Value>12,6</Value>
    </Field>
    </Module>
  </Step>
  <Step>
    <Name>+5V @ 1A</Name>
    <Module>
    <Name>LOAD1</Name>
    <Field>
      <Name>Main</Name>
      <Value>1</Value>
    </Field>
    </Module>
    <Module>
    <Name>MEASURE</Name>
    <Field>
      <Name>Formula</Name>
      <Value>=LOAD1::Vdc( )</Value>
    </Field>
    <Field>
      <Name>ThMin</Name>
      <Value>4,75</Value>
    </Field>
    <Field>
      <Name>ThMax</Name>
      <Value>5,25</Value>
    </Field>
    </Module>
  </Step>
  <Step>
    <Name>+12V @ 1A</Name>
    <Module>
    <Name>LOAD2</Name>
    <Field>
      <Name>Main</Name>
      <Value>1</Value>
    </Field>
    </Module>
    <Module>
    <Name>MEASURE</Name>
    <Field>
      <Name>Formula</Name>
      <Value>=LOAD2::Vdc( )</Value>
    </Field>
    <Field>
      <Name>ThMin</Name>
      <Value>11,4</Value>
    </Field>
    <Field>
      <Name>ThMax</Name>
      <Value>12,6</Value>
    </Field>
    </Module>
    </Step>
  </Step>
  <Step>
    <Name>Prove a 220Vac</Name>
    <Module>
    <Name>ACGEN</Name>
    <Field>
      <Name>Main</Name>
      <Value>220</Value>
    </Field>
    </Module>
    <Step>
    <Name>+5V @ 0A</Name>
    <Module>
      <Name>MEASURE</Name>
      <Field>
      <Name>Formula</Name>
      <Value>=LOAD1::Vdc( )</Value>
      </Field>
      <Field>
      <Name>ThMin</Name>
      <Value>4,75</Value>
      </Field>
      <Field>
      <Name>ThMax</Name>
      <Value>5,25</Value>
    </Field>
    </Module>
  </Step>
  <Step>
    <Name>+12V @ 0A</Name>
    <Module>
    <Name>MEASURE</Name>
    <Field>
      <Name>Formula</Name>
      <Value>=LOAD2::Vdc( )</Value>
    </Field>
    <Field>
      <Name>ThMin</Name>
      <Value>11,4</Value>
    </Field>
    <Field>
      <Name>ThMax</Name>
      <Value>12,6</Value>
    </Field>
    </Module>
  </Step>
  <Step>
    <Name>+5V @ 1A</Name>
    <Module>
      <Name>LOAD1</Name>
      <Field>
      <Name>Main</Name>
      <Value>1</Value>
      </Field>
    </Module>
    <Module>
      <Name>MEASURE</Name>
      <Field>
      <Name>Formula</Name>
      <Value>=LOAD1::Vdc( )</Value>
      </Field>
      <Field>
      <Name>ThMin</Name>
      <Value>4,75</Value>
      </Field>
      <Field>
      <Name>ThMax</Name>
      <Value>5,25</Value>
      </Field>
    </Module>
    </Step>
    <Step>
    <Name>+12V @ 1A</Name>
    <Module>
      <Name>LOAD2</Name>
    <Field>
      <Name>Main</Name>
      <Value>1</Value>
    </Field>
    </Module>
    <Module>
    <Name>MEASURE</Name>
    <Field>
      <Name>Formula</Name>
      <Value>=LOAD2::Vdc( )</Value>
      </Field>
      <Field>
      <Name>ThMin</Name>
      <Value>11,4</Value>
      </Field>
      <Field>
      <Name>ThMax</Name>
      <Value>12,6</Value>
      </Field>
    </Module>
    </Step>
  </Step>
  </Step>
</FunctionalSpecDoc>
```

An example of tree which, starting from the functional specification document, comprises a first node in which the modules are set to the initial condition values. Two connections to an equal number of nodes of reciprocally equal level depart therefrom; supply voltage is set to 110V in one connection and to 20V in the other. During the functional test, the test device implementing the method of the present invention first enters the node in which the supply voltage is set to 110V, after which it goes down by a further level and enters a node in which an infinite resistance load is set to the 5V output of the power supply unit and the no-load voltage is measured, then it goes to the node in which a load value is set so that the output current is 1A and the output voltage is measured, then it goes to the node in which an infinite resistance load is set to the 12V output and the no-load voltage is measured, then a loading resistance is set so that the output current is equal to 1A and the output voltage is measured.

At this point, at the end of the tests related to a supply voltage of 110V, it should pass through the node in which such a voltage is set to 220V and the previously described steps are carried out in the same order.

Therefore, a so-called XML Parser may be used for reading a XML structured document and implementing the model in FIG. 2.

A person skilled in the art, specifically a person skilled in object-oriented programming and formalisms such as UML, will find no difficulty in understanding the modeling technique employed in the present invention, and thus the construction of a device for implementing the above-described method is within the skilled person's reach.

By virtue of the present invention, there is illustrated a method for solving the problem of electronic board functional test allowing unquestionable advantages for electronic companies in:
defining a functional specification by means of a structured document so as to be directly and automatically interpreted by processing means;
modeling a general-purpose, functional testing system.

The first aspect determines the following advantages:
the separation between the information related to the functional specification and the implementing information, so as to make it possible to make general-purpose functional testing systems;
the setting up of a CAD tool used by the electronic designer him or herself for writing the functional specification, by means of which it is possible to transfer his or her competence information directly to the functional testing system, without needing encoding and interpretation, thus automating the product industrialization process also under the functional aspect, with consequent cost reduction due to the number and qualification of the people who are involved in functional test during the production;
the automatic parallel testing of several equivalent devices by using hardware resources, also heterogeneous, present in the testing system and otherwise not used in a single test and the consequent reduction of the test time which is translated into a reduction of testing costs with respect to the single test without an increase of the cost of the testing system. It is worth noting that this aspect is very important in the functional test because the test time greatly depends on the device itself and is statistically high compared with the handling time of the piece. Therefore, the testing time is not compressible for a testing system of equal efficiency in which automatic parallel testing is not performed.
the single management of the functional specifications of the company's own products, so that they are comprehensible by people and machines, inside and outside the same company;
the management of documentation in human language, which may be thus generated automatically from a modeled functional specification;
the possibility of outsourcing the functional test providing only one file containing the functional specification;
the possibility for outsourcers to provide a functional testing service without knowing the implementing features of the product, but being only able to interpret the functional specifications without interpretation doubts.

The second aspect determines the following advantages:
the creation of testing systems formed by a low number of components yet adapted to test all types of products of a company;
the cost reduction of the functional testing systems and their maintenance.

Specifically, with a minimum number of boards it is possible to form testing apparatuses adapted to meet nearly all of the company's needs. For the small remaining number of companies requiring specific functions, said minimum number of common boards are used as components for integrating actuator systems which perform these specific functions.

The specific embodiments herein described do not limit the content of this application which covers all the variants of the invention defined in the claims.

1. A functional testing method of an electronic product adapted to be implemented on data processing means controlling at least one analogue/digital hardware interface with the electronic product to be tested, said hardware interface comprising corresponding software drivers; the method comprising the following steps:
reading a functional test specification document according to a recursive model of structured document through processing means adapted to said document;
driving said analogue/digital interface according to a previously implemented recursive model with input signal for the electronic product, comparing correspondence between the electric/functional behaviour of the electronic product and said structured document, by acquisition of electric output signals from said electronic product;
said recursive model defining a tree in which each node is an object or class which may comprise at least one second object adapted to contain at least one datum and adapted to be associated with at least one driver of said analogue/digital hardware interface.

2. A method according to claim 1, wherein said second object is adapted to be associated with a further software interface.

3. A method according to claim 1, wherein said data may contain fixed values or values depending on values contained in one datum of any said second object of the same node or of a hierarchically higher node.

4. A method according to claim 1, wherein said object is not valorized and/or does not comprise or refer to any datum.

5. A functional testing device for an electronic product comprising:
means for interfacing the analogue/digital hardware with said electronic product, adapted to generate electric input signals for the electronic product and adapted to acquire electric output signals from the electronic product for performing a functional testing trial;
processing means adapted to read a document of functional testing specification of said electronic product structured according to a recursive model and defining a tree in which each node is an object or class which comprises at least one second object adapted to contain at least one datum and adapted to be associated with said at least one driver of said at least one analogue/digital hardware interface; said processing means being adapted to compare the correspondence of said electric/functional behaviour of the electronic product and said document;
software or driver interfacing means between said processing means and said hardware interfacing means, associated with at least one said second object.

6. A functional testing device according to claim 5, further integrating assisting means for the assisted setting up of said document of functional testing specification according to said recursive model of structured document.

7. A testing device according to a claim 5, further comprising electronic design assisting means.

8. A computer program comprising code means adapted to implement the steps defined by the tree defined by the recursive model according to claim 1, when said program is run on a computer.

9. Computer-readable means comprising a program recorded on the computer-readable means, said means comprising a program code adapted to implement the steps defined by the tree defined by the recursive model according to claim 1, when said program is run on a computer.
